(19) United States
(12) Patent Application Publication
(10) Pub. No.: US 2025/0278450 A1
(43) Pub. Date: Sep. 4, 2025

(54) SYSTEMS AND METHODS INCLUDING COMBINATORIAL OPTIMIZATION CIRCUITRY UTILIZING SRAM CELLS AND NOISE

(71) Applicant: University of Washington, Seattle, WA (US)

(72) Inventors: Sajjad MOAZENI, Seattle, WA (US); Alana DEE, Seattle, WA (US)

(21) Appl. No.: 18/862,145

(22) PCT Filed: May 3, 2023
(86) PCT No.: PCT/US2023/020867

§ 371 Date: Oct. 31, 2024

Related U.S. Application Data
(60) Provisional application No. 63/337,951, filed on May 3, 2022.

(51) Int. Cl. G06F 17/11; G06F 17/16

(52) U.S. Cl. CPC G06F 17/11; G06F 17/16

(57) ABSTRACT

Embodiments of the present disclosure provide systems, devices, and methods for solving combinatorial optimization problems using a device that functions as a CMOS Ising machine. An example device includes circuitry for linear operation, circuitry for noise addition, and circuitry for nonlinear operation. The circuitry for linear operation includes a plurality of SRAM cells in an SRAM cell array that store values of a coupling matrix. In some embodiments, circuitry for linear operation, circuitry for noise addition, and circuitry for nonlinear operation may be fabricated on a semiconductor substrate. In some embodiments, the device may include a feedback loop including circuitry for linear operation, circuitry for noise addition, and circuitry for nonlinear operation, wherein the circuitry for linear operation is coupled to the circuitry for nonlinear operation.

### CROSS-REFERENCE TO RELATED APPLICATION(S)

This application claims priority to U.S. Provisional Application No. 63/337,951, filed May 3, 2022, which application is hereby incorporated by reference, in its entirety, for any purpose.

### BACKGROUND

Combinatorial and discrete optimization problems are used in many fields, from artificial intelligence to supply chain management and finance. Classical computing algorithms are often insufficient for solving these important problems as they are mainly nondeterministic polynomial-time (NP)-hard problems. The Ising machine is an emerging quantum-inspired paradigm that can accelerate these computations through a fundamentally different approach. However, despite many efforts in developing practical Ising machine hardware, previous solutions cannot effectively scale for real-world sized optimization problems. Some examples use a network of coupled cryogenic super-conducting spins to find the minimum energy state for optimization problems such as MAXCUT. This scheme requires kW-range power to cool down a refrigerator-sized system, leading to million-dollar costs. Another approach is to use classical optical or electrical oscillators to determine the ground state. Optical oscillators require non-trivial, nonlinear materials to fabricate, while still lacking the scalability and energy efficiency required for practical implementation. Similarly, a coupled network of electrical oscillators is difficult to scale and integrate with other computing circuitry due to cross-coupling. Other example approaches to build a practical Ising machine are simulated-based methods like simulated bifurcation and simulated annealing, which uses a nonlinear-linear feedback loop to simulate the oscillatory behavior. Such methods have been shown to be mathematically equivalent to a coupled oscillator network with similar performance advantages. Yet, currently proposed simulated bifurcation implementations are neither efficient in terms of energy and speed nor compatible with mainstream semiconductor manufacturing. For instance, memresistive cross-bar based methods may be slow (˜MHz range) and not complementary metal-oxide semiconductor (CMOS) compatible, and may require large reprogramming time. Fully digital implementations of Ising machines on graphical processing units (GPUs) or field-programmable gate arrays (FPGAs) are hard to scale, reducing the practicality of using them to solve real-world problems. Current CMOS-based Ising machines are based on coupled networks of oscillators, which pose difficulties in scaling and integration with other circuity.

### SUMMARY

Examples described herein are directed towards systems, devices, and methods for solving combinatorial optimization problems using a device that functions as a CMOS Ising machine. In some embodiments, the device may include circuitry for linear operation, circuitry for noise addition, and circuitry for nonlinear operation, wherein the circuitry for linear operation includes a plurality of static random memory (SRAM) cells. In some embodiments, the device may include a feedback loop including circuitry for linear operation, circuitry for noise addition, and circuitry for nonlinear operation, wherein the circuitry for linear operation may be coupled to the circuitry for nonlinear operation. In some embodiments, circuitry for linear operation, circuitry for noise addition, and circuitry for nonlinear operation may be fabricated on a semiconductor substrate.

Various embodiments described herein are directed to systems, devices, and methods for solving combinatorial optimization problems using a device that functions as a CMOS Ising machine. The device may include, but is not limited to, circuitry for linear operation including a plurality of SRAM cell array including a plurality of cells, circuitry for noise addition, and circuitry for nonlinear operation.

In some embodiments, examples of a method may include applying one or more input vector values to combinatorial optimization circuitry, performing multiple iterations of calculations using the combinatorial optimization circuitry, and providing one or more output vector values from the multiple iterations of calculations, the output vector values representative of a solution to the optimization problem. Each iteration of the multiple iterations may include: performing a linear operation on the one or more input vector values utilizing SRAM cells programmed to store values of a coupling matrix representative of an optimization problem; adding noise on signals resulted from the linear operation; and performing a nonlinear operation on the signals with added noise. In some examples, the linear operation may include matrix multiplication between the one or more input vector values and the coupling matrix.

In some examples, the noise may be Gaussian noise or discrete uniform noise. In some examples, each iteration comprises multiple linear operations followed by nonlinear operations in a feedback configuration.

In some examples, the method may further include mapping differential voltages from the SRAM cells to variable pulse widths using a reference voltage.

In some examples, the method may further include programming the SRAM cells to store values of the coupling matrix representative of the optimization problem. In some examples, bias voltages may be provided to at least a portion of cells in the SRAM cells. In some examples, bias voltages may be provided to every cell of the SRAM cells. In some examples, different bias voltages are provided to diagonal cells and nondiagonal cells of an SRAM cell array comprising the SRAM cells. In some examples, the optimization problem is a MAXCUT problem.

In some embodiments, a device may include a processor and combinatorial optimization circuitry. In some examples, the processor and the combinatorial optimization circuitry may be formed in a semiconductor substrate. In some examples, the combinatorial optimization circuitry may include a plurality of SRAM cells; noise generation circuitry coupled to the plurality of SRAM cells; and circuitry coupled to the noise generation circuitry, and configured to perform a nonlinear operation. The device may further include conductive traces on the semiconductor substrate, coupling the processor to the combinatorial optimization circuitry. In some examples, the device may include multiple instances of: the plurality of SRAM cells; the noise generation circuitry; and the circuitry that performs a nonlinear operation, arranged in a feedback configuration. The processor may provide one or more input vector values to the combinatorial optimization circuitry, receive one or more output vector values from the combinatorial optimization circuitry, and further solve an optimization problem using the one or more output vector values.

In some examples, the plurality of SRAM cells may include diagonal cells coupled to respective shift registers. In some examples, the optimization problem is a MAXCUT problem.

In some embodiments, a device may include combinatorial optimization circuitry that may perform iterations of calculations and provide an output from the multiple iterations of calculations. The output may be representative of a solution to an optimization problem. The combinatorial optimization circuitry may include first circuitry, noise generation circuitry, and second circuitry coupled to the first circuitry. The first circuitry may receive input vector values and perform a linear operation on the input vector values to provide first signals. In some examples, the first circuitry may include a plurality of SRAM cells that may store values of a coupling matrix representative of the optimization problem and further receive the input vector values and provide the first signals. The noise generation circuitry may add noise on the first signal and to provide second signals. The second circuitry may perform a nonlinear operation on the second signals and provide output vector values to the first circuitry.

In some examples, the device may include an SRAM programmer that may program the plurality of SRAM cells to store the values of the coupling matrix representative of the optimization problem. In some examples, the first circuitry may include shift registers coupled to respective diagonal cells of an SRAM cell array including the SRAM cells, wherein the shift registers may provide respective bias voltages to the diagonal cells of the SRAM cell array. In some examples, the noise circuitry may include a current-based digital-to-analog converter including a current mirror circuit and a noise decay generator including a resistive digital-to-analog converter.

In some examples, the second circuitry may include one or more biasing transistors that perform nonlinear operation. In some examples, the second circuitry may include a comparator circuit configured to compare the output differential voltages from the SRAM cells with a reference voltage and may provide variable pulse widths based on the comparison.

In some examples, the first circuitry may multiply the input vector values by the values of the coupling matrix to provide products and to sum the products. In some examples, each SRAM cell of the plurality of SRAM cells may receive a respective input vector value on a word line coupled to each SRAM cell, and provide currents on a pair of bit lines to provide a differential voltage corresponding to an output vector. The second circuitry may be coupled to a plurality of word lines including the word line that provides a corresponding output vector value of the output vector values based on the nonlinear operation on the differential voltage.

### BRIEF DESCRIPTION OF THE DRAWINGS

FIG. 1 is a schematic illustration of a system including combinatorial optimization circuitry in accordance with examples described herein.

FIG. 2 is a schematic illustration of a flowchart of solving combinatorial optimization problems in accordance with examples described herein.

FIG. 3 is a schematic illustration of a block diagram representing functionalities of combinatorial optimization circuitry in accordance with examples described herein.

FIG. 4 shows an equation representing a vector represented by signals on word lines in combinatorial optimization circuitry in accordance with examples described herein.

FIG. 5 shows an equation representing a linear operation of combinatorial optimization problems in vector representation in accordance with examples described herein.

FIG. 6 shows an equation representing a linear operation of combinatorial optimization problems in accordance with examples described herein.

FIG. 7 shows an equation representing a linear operation of combinatorial optimization problems in accordance with examples described herein.

FIG. 8 shows an equation representing an equation for computing MAXCUT in accordance with examples described herein.

FIG. 9 is a schematic illustration of a device implementing an Ising machine including an SRAM cell array for linear operations in accordance with examples described herein.

FIGS. 10A and 10B are schematic illustrations of circuitry for linear operation including an SRAM cell array in accordance with examples described herein.

FIG. 11 illustrates is a schematic illustration of circuitry for noise addition in accordance with examples described herein.

FIG. 12A illustrates an example of a comparator in circuitry for nonlinear operation in accordance with examples described herein.

FIG. 12B illustrates a relationship between differential signals of the comparator in accordance with examples described herein.

FIG. 13A is a schematic illustration of a device implementing an Ising machine including comparators for nonlinear operations in accordance with examples described herein.

FIG. 13B is a schematic illustration of an SRAM cell array in accordance with examples described herein.

FIG. 14 is a schematic illustration of a device implementing an Ising machine including a multi-core architecture in accordance with examples described herein.

### DETAILED DESCRIPTION

The following description of certain embodiments is merely exemplary in nature and is in no way intended to limit the scope of the disclosure or its applications or uses. In the following detailed description of embodiments of the present systems, devices, and methods, reference is made to the accompanying drawings which form a part hereof, and which are shown by way of illustration specific to embodiments in which the described systems and methods may be practiced. It is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense for the appended claims.

An entirely CMOS Ising machine may be advantageous as it can be integrated with current central processing units (CPUs) and GPUs to expand computational abilities while using a well-developed fabrication process. Thus, systems and/or methods implementing the concept of a simulated bifurcation, or non-oscillatory, CMOS Ising machine on the same substrate that may be fabricated on the same process may be desired.

Examples of fully CMOS Ising machines may be based on simulated bifurcation or annealing approaches, and may utilize a linear-nonlinear feedback loop to determine the optimal solution. The linear operation may be realized by exploiting an analog in-memory computing technique. By doing so, the system may address pitfalls of other Ising machines, namely energy efficiency, CMOS compatibility, scalability, and/or speed. The system may further add noise to the output of the linear operation to improve performance. A programmable nonlinearity may be provided by biasing transistors in nonlinear regimes and using comparator circuits. Examples of systems described herein may achieve all-to-all connectivity, decrease the overall time to the final (e.g., optimal solution), and reduce reprogramming time.

In-memory analog computing may be provided in some examples, which may improve energy efficiency. This technology may allow for exploration of the feasibility of solving graphs beyond simple binary problems and evaluation of the mixed-signal CMOS architecture for various random graph types. The architectures described herein can be used to realize a variety of algorithms such as: simulated annealing, simulated bifurcation, and Hopefield neural networks (HNN) to solve combinatorial optimization problems. Note that these algorithms are analog-based computing (e.g., unlike the conventional neural networks), which can benefit from the analog-domain implementations due to the noisy operation. This architecture may be referred to as “mixed-signal” as it performs the linear operation in the analog-domain and the nonlinear operation in the digital mode. Overall, systems described herein may have some of features as follows.

In some examples, systems may include one or more SRAM arrays. While emerging memories may have advantages like non-volatility, they generally suffer from yield issues, process variation, repeatability, and slow programming time, and they cannot readily get integrated with advanced CMOS processes. SRAM cells are generally available in any CMOS technology with extremely compact footprints and high yield. This allows the architecture to be implemented in existing CMOS technology using commercial foundry processes at low cost, high speed, and low power, unlike previous approaches that propose using emerging memories such as ReRAM for the compute in-memory schemes.

The simulated approaches for solving combinatorial problems are used, and accordingly any MAXCUT problem may be implemented unconditionally. This is an advantage over oscillation-based solutions where the connectivity can be physically limited by neighboring oscillators. Additionally, compared with previous simulated-based demonstrations, systems described herein may not suffer from, or may have reduced, cross-talk between the signals nor time-multiplexing latencies to provide the all-to-all connectivity.

In some examples, systems may utilize a multi-core architecture including a plurality of multiply-accumulate (MAC) cores (e.g., processors) to implement a linear-nonlinear feedback loop for simulated bifurcation of a linear operation and a nonlinear operation. A fully parallel architecture is described herein by tiling the MAC and nonlinear block cores in a quad fashion to overcome this bottleneck. Process variations and mismatch between the cores will not degrade the accuracy and time-to-solution in simulated bifurcations and annealing. Moreover, this scheme is fully compatible with using SRAM word lines and bit lines for the MAC realization.

Currently proposed approaches use a single-core analog solver and need to loop back the spin/variable values by parallel-to-serial multiplexing; the multiplexing latency overhead can easily dominate the iteration time and overall compute time.

Advantageously, systems and methods described herein may utilize circuitry for linear operation, circuitry for noise addition, and circuitry for nonlinear operation. Examples of Ising machines utilizing such systems and methods not only integrate with today's most advanced computing systems in data centers and supercomputers. In addition to integrating such advanced computing systems in data centers and supercomputers, examples of systems and methods described herein may integrate provide edge devices such as drones and wearables. Such integration may be implemented based on CMOS technology, for example. While various advantages of example systems and methods have been described, it is to be understood that not all examples of the described technology may have all, or even any, of the described advantages.

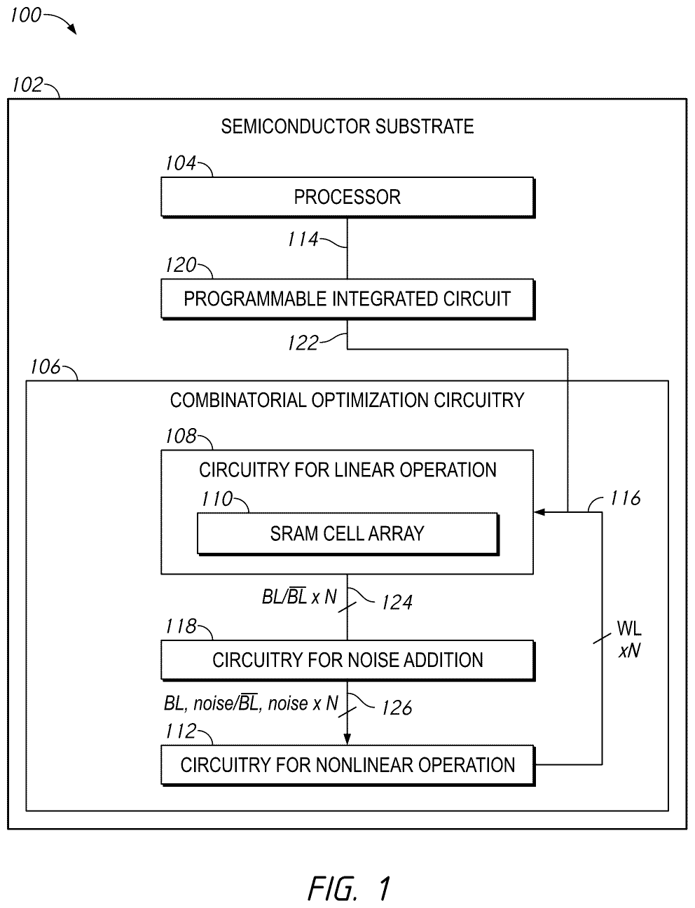

FIG. 1 is a schematic illustration of a system 100 including combinatorial optimization circuitry 106 in accordance with examples described herein. It should be understood that this and other arrangements and elements (e.g., machines, interfaces, function, orders, and groupings of functions, etc.) can be used in addition to or instead of those shown, and some elements may be omitted altogether. Various functions described herein as being performed by one or more components may be carried out by firmware, hardware, and/or software. For instance, and as described herein, various functions may be carried out by a processor executing instructions stored in one or more memory devices and a memory executing in-memory computations.

A system 100 of FIG. 1 includes a semiconductor substrate 102. Examples described herein may accordingly include a semiconductor substrate 102. The semiconductor substrate 102 may be implemented, for example, using a silicon substrate. Other substrates may be used. Advantageously, semiconductor processing techniques may be used to fabricate combinatorial optimization circuitry in a same substrate as one or more CPUs, GPUs, and/or other circuitry.

In some examples, the system 100 may include one or more processors, such as a processor 104 formed on the semiconductor substrate 102. Examples of processors including one or more CPUs, GPUs, controllers, microcontrollers, processor core(s), and/or other processing circuitry.

The system 100 may include combinatorial optimization circuitry 106 formed on the semiconductor substrate 102. In some examples, the system 100 may further include a programmable integrated circuit 120, such as a field programmable gate array (FPGA). In some embodiments, the processor 104 and the combinatorial optimization circuitry 106 may be coupled by conductive traces 114 and/or 122. The combinatorial optimization circuitry 106 may include circuitry for linear operation 108, circuitry for noise addition 118, and circuitry for nonlinear operation 112. In some embodiments, the circuitry for linear operation 108 and the circuitry for nonlinear operation 112 may be coupled to each other by N pairs of bit lines 124 (BL and [symbol] ) and N pairs of bit lines 126 (BL, noise, and B̅L̅, noise|), and N pairs of word lines 116 (WL and [symbol] ), where N is a natural number. The circuitry for linear operation 108 may include an SRAM cell array 110 including a plurality of SRAM cells. In some examples, the SRAM cell array 110 may have N columns and N rows and the plurality of SRAM cells may be arranged in the N columns and N rows. The plurality of SRAM cells may have input nodes coupled to respective word lines 116 and output nodes coupled to respective bit lines 124. It should be understood that the system 100 shown in FIG. 1 is an example of one suitable architecture for implementing certain aspects of the present disclosure. Additional, fewer, and/or different components may be used in other examples.

In some examples, the system 100 may be implemented as a device including the processor 104 and the combinatorial optimization circuitry 106. In some embodiments, the system 100 may be fabricated and tested in a standard CMOS process at room temperature. Thus, the system 100 may integrate the processor 104, such as a commercial CPU or GPU; the programmable integrated circuit 120; and the combinatorial optimization circuitry 106. However, it should be noted that the system 100 may be implemented as separate devices, one including the processor 104 including functionalities of the programmable integrated circuit 120 and another including the combinatorial optimization circuitry 106. Any and all such variations, and any combination thereof, are contemplated to be within the scope of implementations of the present disclosure.

Further, although the processor 104, the programmable integrated circuit 120, and the combinatorial optimization circuitry 106 are illustrated as separate components of the system 100, any number of components can be used to perform the functionality described herein. Although illustrated as being a part of the system 100, the components can be distributed via any number of devices. For example, the processor 104 can be provided via one device or multiple devices of a single or multiple kinds, while the combinatorial optimization circuitry 106 may be provided as one or more CMOS devices of a single or multiple kinds.

Examples of the combinatorial optimization circuitry 106 described herein may generally receive input signals and provide output signals at the conductive traces 122 of FIG. 1. In some examples, the circuitry for linear operation 108 may receive the input signals on the conductive traces 122 and the circuitry for nonlinear operation 112 may provide output signals on the conductive traces 122. However, other arrangements of the circuitry for linear operation 108 and the circuitry for nonlinear operation 112 may be used in other examples. In some examples, the circuitry for nonlinear operation 112 may receive the input signals on the conductive traces 122 and the circuitry for linear operation 108 may provide output signals on the conductive traces 122. While the circuitry for linear operation 108, the circuitry for noise addition 118, and the circuitry for nonlinear operation 112 are shown in FIG. 1, generally any number of the circuitry for linear operation 108, the circuitry for noise addition 118, and the circuitry for nonlinear operation 112 may be included in the combinatorial optimization circuitry 106 described herein.

In some examples, input vector values may be applied to the conductive traces 122 that are coupled to the word lines 116 (WL and [symbol] ). A linear operation on the input vector values may be performed by the circuitry for linear operation 108. In some examples, the linear operation on the input vector values may be performed utilizing a plurality of cells of the SRAM cell array 110. In some examples, the plurality of cells of the SRAM cell array 110 may be programmed to store values of a coupling matrix representative of an optimization problem. In some examples, the optimization problem may include a MAXCUT problem. In some examples, the linear operation may be a linear transformation, such as matrix multiplication. Based on the stored values in the plurality of cells of the SRAM cell array 110, which correspond to the coupling matrix to multiply by, the plurality of cells of the SRAM cell array 110 may provide signals on the bit lines 124 (BL and [symbol] ). In some examples, the signals on the bit lines 124 (BL and [symbol] ) may have a voltage differential corresponding to elements in a solution vector.

Input nodes of the circuitry for noise addition 118 may be coupled to the N pairs of bit lines 124 (BL and [symbol] ). The circuitry for noise addition 118 may add noise on the signals from the plurality of cells of the SRAM cell array 110 on the bit lines 124 (BL and [symbol] ), and provide the signals with noise on the N pairs of bit lines 126 (BL, noise, and B̅L̅, noise|). Operations performed in the circuitry for linear operation 108 and the circuitry for noise addition 118 may be implemented in an analog domain, and added noise is generally beneficial to system bifurcation including linear-nonlinear operations. In some examples, components of the combinatorial optimization circuitry 106 may be fabricated on the semiconductor substrates 102 as CMOS based, and the processing speed may be faster, as there is no conversion with the digital domain before and after computation.

Input nodes of the circuitry for nonlinear operation 112 may be coupled to the N pairs of bit lines 126 (BL, noise, and B̅L̅, noise|). A nonlinear operation on the signals with noise may be performed by the circuitry for nonlinear operation 112. In some examples, the nonlinear operation on the input vector values may be performed utilizing a comparator circuit in the circuitry for nonlinear operation 112. In some examples, a programmable nonlinearity may be provided by biasing transistors in the circuitry for nonlinear operation 112. The circuitry for nonlinear operation 112 may provide output vector values.

Output nodes of the circuitry for nonlinear operation 112 and input nodes of the circuitry for linear operation 108 by the N pairs of word lines 116 (WL and [symbol] ) may be coupled to one another. As described above, the circuitry for linear operation 108, the circuitry for noise addition 118, and the circuitry for nonlinear operation 112 may be arranged in a feedback loop. Thus, the output vector values of the circuitry for nonlinear operation 112 may be provided as the input vector values of the circuitry for linear operation 108. Alternatively or eventually, the output vector values may be provided as representative of a solution to the optimization problem.

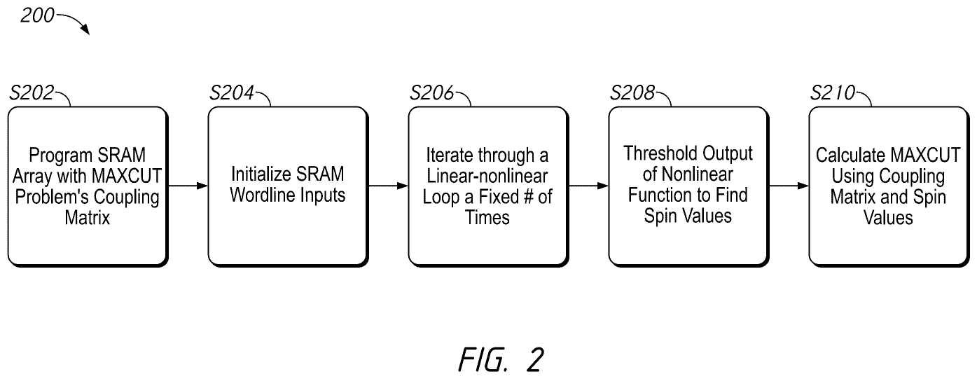

FIG. 2 is a schematic illustration of a flowchart 200 of solving combinatorial optimization problems in accordance with examples described herein. Example operations of the system 100 for solving combinatorial optimization problems to support the functionality and relevant design decisions are described herein. In the example operations, a procedure of solving a combinatorial optimization problem, such as the MAXCUT problem, is described. The MAXCUT problem generally maps easily to an Ising machine; thus it may be solved by using the combinatorial optimization circuitry 106 of the system 100. However, other combinatorial problems may also be reduced to be solved by using the combinatorial optimization circuitry 106 of the system 100 in an analogous fashion.

In the MAXCUT problem, there is a graph with a number N of nodes and some number of edge connections among those nodes. The optimal solution to this problem may be the maximum number of edge connections one can cut through without repeatedly cutting through an edge. In a weighted graph, it may be the maximum sum of the weights of the edges that are cut through. These edge connections and their weights are encoded through a coupling matrix, where position i-j corresponds to the weight of the edge connecting node i and node j. If the graph is unweighted, the weight is 1; and if there is no edge, the weight is 0. An N-by-N coupling matrix derived in this fashion can then be used to represent the MAXCUT problem.

In step S202, example systems or devices, such as the system 100 described herein, may be programming the N-by-N coupling matrix. For example, the circuitry for linear operation 108 may perform the linear operation by using an N×N SRAM cell array 110 including the plurality of SRAM cells. In some examples, the linear operation may be performed by computing a vector-matrix multiplication in the plurality of cells of the SRAM cell array 110. In step S202, the N-by-N coupling matrix may be programmed on the N×N SRAM cell array 110. For example, an SRAM cell in row i and column j of the plurality of SRAM cell array 110 may be programmed to store a value associated with row i and column j in the coupling matrix. In some examples, the processor 104 may directly program the coupling matrix on the SRAM cell array 110. In some examples, the processor 104 may program the coupling matrix on the SRAM cell array 110 via the programmable integrated circuit 120 that may communicate with components fabricated on the semiconductor substrate 102. In some examples, the processor 104 may program the coupling matrix on the SRAM cell array 110 via an SRAM programming circuit that may be fabricated on the semiconductor substrate 102.

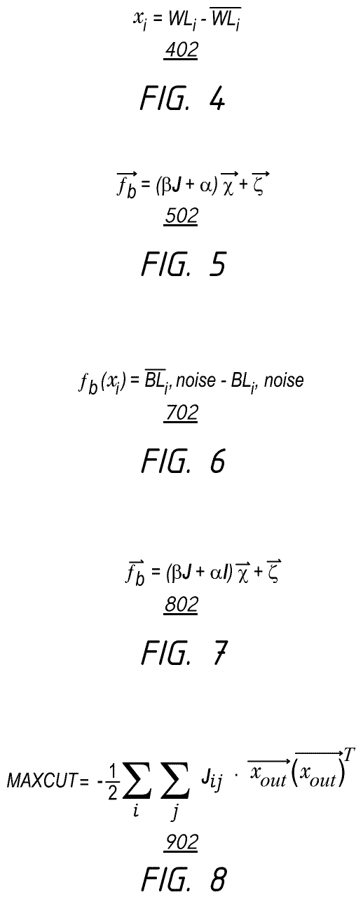

In step S204, the word lines 116 coupled to input nodes of the SRAM cell array 110 may be initialized. For example, the input nodes of the SRAM cell array 110 may receive an input vector x initialized to zero at the step S204. In some examples, the word lines 116 are coupled to the circuitry for nonlinear operation 112 that provides output vector (e.g., a spin state vector) on the word lines 116, and further coupled to the conductive traces 122 that are coupled to the programmable integrated circuit 120. Because the conductive traces 122 may be coupled to the word lines 116, elements of a spin state vector that is an output vector of the circuitry for nonlinear operation 112 may be initialized to “0” in the step S204. Each element of the spin state vector may be calculated by differential input of word lines 116 as represented in an equation 402 in FIG. 4.

In step S206, multiple iterations of calculations using the combinatorial optimization circuitry 106 may be performed.

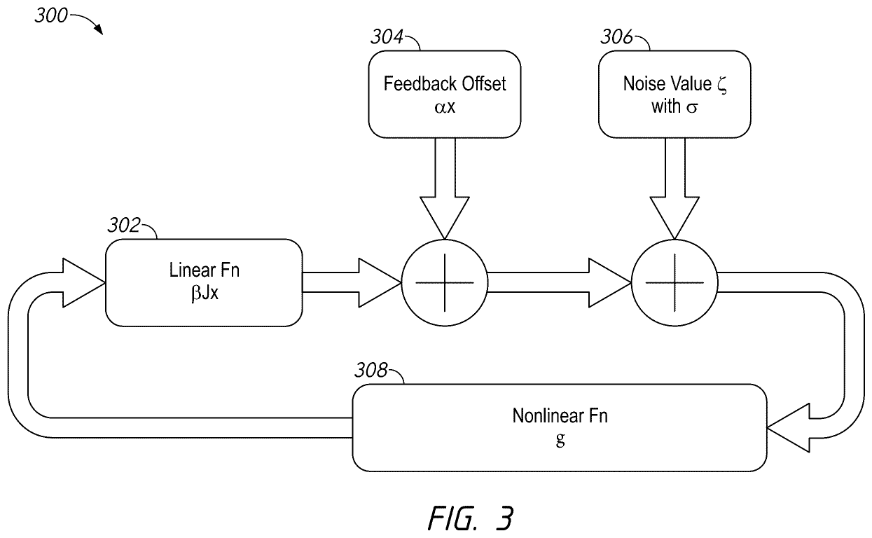

FIG. 3 is a schematic illustration of a linear-nonlinear feedback loop system 300 representing functionalities of the combinatorial optimization circuitry 106 in accordance with examples described herein. The system 300 may perform the linear-nonlinear loop operation to find a solution of an optimization problem that may include, for example, a MAXCUT problem.

Each iteration of the multiple iterations may include performing a linear function βJx 302, such as matrix multiplication using with the coupling matrix J on the circuitry for linear operation 108 for input vector x and adding feedback offsets αx 304 on the circuitry for linear operation 108, adding noise ζ with a standard deviation σ 306 on the circuitry for noise addition 118, and performing a nonlinear function g 308 on the circuitry for nonlinear operation 112. In some examples, the noise may be an independent Gaussian noise [symbol] added to each element of the vector output from the circuitry for noise addition 118. For example, α may represent a feedback strength and β may represent a coupling strength of the system 300. In some examples, the loop parameters α and β may be tuned in simulation and experimentally. The loop parameters α and β are crucial to an operation of an Ising machine device. In the feedback system 300 and equations 502, and 702, α and β are loop parameters that determine whether the system will converge to an optimal value as well as the speed at which it converges.

Thus, a vector f_{b} output from the circuitry for noise addition 118 may be calculated by the vector equation 502 shown in FIG. 5. The vector f_{b} is an input vector for the circuitry for nonlinear operation 112. Each input signal f(xᵢ) that is each element of the input vector may be represented by the equation 502 in FIG. 5. Alternatively, each input signal f(xᵢ) of the circuitry for nonlinear operation 112 may be obtained as differentials between the N pairs of bit lines 126 (BL, noise, and B̅L̅, noise|) as represented in the equation 702 in FIG. 6.

Each input signal fb(x) may be provided as input to a nonlinear operation that is performed by the circuitry for nonlinear operation 112. The nonlinear operation may be represented as the nonlinear function g 308. After performing the nonlinear function g 308, the result of the nonlinear function g may be provided as output signals from the circuitry for nonlinear operation 112, and the output signals are applied as a new input vector x into the linear function βjx 302 to be performed by the circuitry for linear operation 108. Thus, the new input vector x then undergoes the linear matrix multiplication 302 with the addition of the offset 304 and the addition of noise 306.

This feedback loop operation repeats until the values of an output vector (e.g., a spin state vector) bifurcate and settle to two states. These two states, one above zero and the other below zero, represent the node grouping that yields the output vector that may result in an input vector x of a MAXCUT problem represented as an equation 902 in FIG. 8. To find the output vector, a location of the solution in the MAXCUT problem may be determined. To determine the location of the solution, grouping a graph's nodes in the MAXCUT problem into two groups may be effective, as the MAXCUT crosses once through an edge connecting any two nodes of opposing groups. Practically, the solution location can be represented by an N×1 vector, where each element is in one of two states, theoretically a “1” or a “−1,” that is often referred to as the “spin,” due to the inspiration from quantum computing. Because elements of the input vector were initialized to “0”, which is an in-between, unstable state, the unstable state allows for the device to bifurcate properly to the spin states corresponding to the optimal solution. The term “spin state” may be used to refer to the value of an output vector or an intermediate vector as described herein. However, it is to be understood that the term “spin state” is not intended to limit the described vectors or values as representing any particular physical state or representation.

After the loop is run for a fixed number of times, in step S208, the spin state vector is read out to determine the solution location. While the output vector may be referred to as a spin state vector herein, and spin states may be discussed, it is to be understood that generally any output vector may be provided. The output vector may generally represent a final and/or intermediate proposed solution to the optimization problem. Depending on the nonlinearity implemented, the vector may be read out directly or first digitized for effective node grouping. The minimum number of iterations to achieve certain success rates is determined through simulation and experimental results.

Once the solution location is found in step S208, the MAXCUT value can be calculated through the inverse of the Ising Energy of the system in step S210. In some examples, calculation of the MAXCUT value may be performed in the processor 104, which may be on the same semiconductor substrate 102 or on a different chip connected by a bus, etc. When the digitized spin state vector \vec{xₒᵤₜ} is obtained after bifurcation from the circuitry for nonlinear operation 112, the spin state vector \vec{xₒᵤₜ} may be multiplied by its transpose to determine edges that are between nodes of different groupings in the graph. Then an element-wise multiplication with the coupling matrix J may be performed to properly weight the edge cut. Finally, the result of the multiplication may be divided by 2 due to the symmetry of the coupling matrix J and negated, since the MAXCUT occurs at the minimum energy level. Summation may be performed over all values of i and j, representing the row and column indices of the matrix J, respectively. The resulting calculation may be represented by the equation 902 in FIG. 8. In some examples, the MAXCUT calculation may be the final step to determine the solution to the optimization problem; however, the solution location provided by the spin state vector may be just as useful for real-world applications. Accordingly, devices described herein may be utilized to generate an output vector corresponding to xₒᵤₜ in the above MAXCUT representative equation 902. The output vector may be used to generate the MAXCUT value or other values in other examples. Accordingly, post-processing circuitry may be provided in some examples to conduct further processing on an output vector.

By using the system 100 implementing an Ising machine as described herein, combinatorial and discrete optimization problems, such as the MAXCUT problems used in many fields, from artificial intelligence to supply chain management and finance, may be solved in an accelerated manner while scaling the system 100 suitable for real-world sized optimization problems. For example, the system 100 may be used for neural network computation, graphics processing for display, network design, statistical physics and VLSI design, circuit layout design, data clustering, route planning and navigation, warehouse design, portfolio optimization, or some other applications. For example, one or more solutions to problems provided by systems described herein, including Ising machine(s), may be used by the system 100 to further provide processing that results in an output computation, image for display, data cluster, statistical physics output, VLSI design output, route plan or navigation, etc. The output may be provided to one or more other systems, and/or may be displayed on a display. In some examples, a product may be designed and/or manufactured in accordance with the output. For example, an Ising machine output may be used during a VLSI design and/or circuit layout design application. A resulting VLSI design and/or circuit layout design may be identified and an integrated circuit may be fabricated in accordance with the design. In another example, an Ising machine output may be used in route planning and navigation, and an identified route may be provided to a user (e.g., a driver). The user may travel the route in accordance with instructions for the identified route.

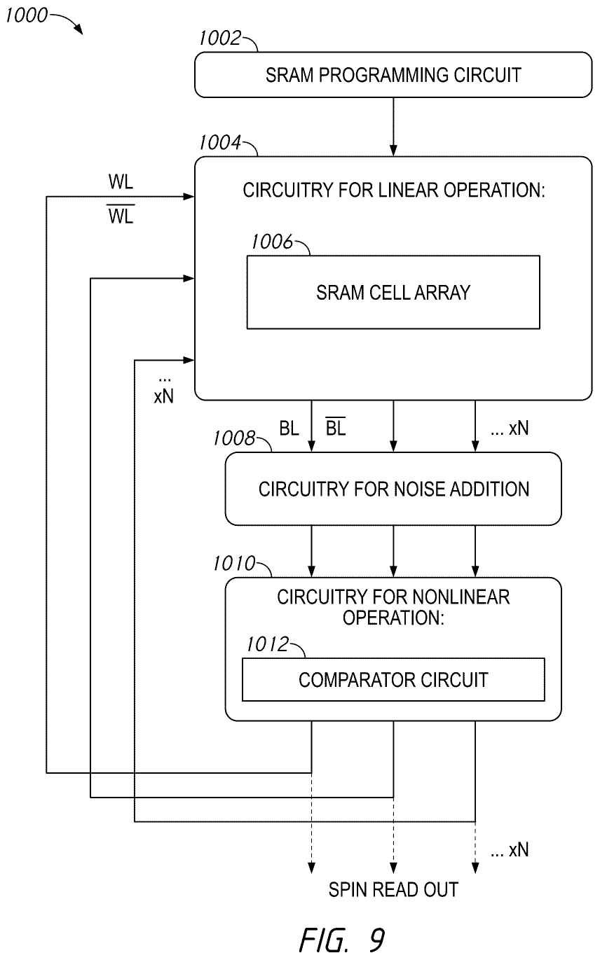

Example operation of an example CMOS Ising machine described above may be implemented in multiple ways. FIG. 9 is a schematic illustration of a device 1000 implementing an Ising machine including an SRAM cell array 1006 for linear operations in accordance with examples described herein. The device 1000 may be an example implementation of combinatorial optimization circuitry (e.g., an Ising machine) arranged in accordance with techniques described herein. Generally, combinatorial optimization circuitry described herein may be used to solve or otherwise address optimization problems. In some examples, the device 1000 may perform at least a portion of MAXCUT optimization problems. The device 1000 may include circuitry for linear operation 1004, circuitry for noise addition 1008, and circuitry for nonlinear operation 1010. In some examples, the circuitry for linear operation 1004 and the circuitry for nonlinear operation 1010 may be coupled to each other, and feedback may be provided from one to the other.

In the example of FIG. 9, the circuitry for linear operation 1004 is illustrated as an initial circuitry block, followed by the circuitry for noise addition 1008 and the circuitry for nonlinear operation 1010, and feedback signals representing an output vector from the circuitry for nonlinear operation 1010 may be provided to the circuitry for linear operation 1004. However, it is to be understood that the circuitry may be provided in a different order. In other examples, the circuitry for nonlinear operation 1010 may receive an input vector, followed by the circuitry for linear operation 1004 and the circuitry for noise addition 1008, where feedback signals from the circuitry for linear operation 1004 may be provided to the circuitry for nonlinear operation 1010.

During operations, input vector values may be provided to the device 1000, such as the circuitry for linear operation 1004. Multiple iterations of calculations may be performed on the device 1000, with each iteration including an operation performed by the circuitry for linear operation 1004, noise addition by the circuitry for noise addition 1008, and an operation performed by the circuitry for nonlinear operation 1010. In the example of FIG. 9, feedback values may be provided from the circuitry for nonlinear operation 1010 to the circuitry for linear operation 1004 and an output vector may be provided from the circuitry for nonlinear operation 1010. In some examples, the output vector may be provided as the feedback values. After a number of iterations, a final output vector may be representative to a solution to the optimization problem.

Generally, the circuitry for linear operation 1004 may include an SRAM cell array 1006 including one or more SRAM cells, and the SRAM cells may be programmed to store values of a coupling matrix representative of an optimization problem. In some examples, the linear operation may be matrix multiplication. In the example of FIG. 9, the device 1000 may include an SRAM programming circuit 1002. In some examples, the SRAM programming circuit 1002 and the SRAM cell array 1006 may be fabricated on a same substrate (e.g., the semiconductor substrate 102) as CMOS devices. The SRAM programming circuit 1002 may program the SRAM cells of the SRAM cell array 1006 to store the values of the coupling matrix representative of the optimization problem. In some examples, the values to be stored in the SRAM cells of the SRAM cell array 1006 may be based on loop parameters that determine whether the feedback loop will converge to an optimal value as well as the speed at which it converges. In some examples, the loop parameters may be the feedback strength α and the coupling strength β. In some examples, the loop parameters α and β may be tuned in simulation and experimentally. The loop parameters α and β may be crucial to an operation of an Ising machine device.

In some examples, input vector values may be applied to word lines (WL and [symbol] ). A linear operation on the input vector values may be performed by the circuitry for linear operation 1004. In some examples, the linear operation on the input vector values, such as the matrix multiplication, may be performed utilizing the plurality of cells of the SRAM cell array 1006 storing the values of the coupling matrix representative of the optimization problem. In some examples, the optimization problem may include a MAXCUT problem. Based on the stored values in the plurality of cells of the SRAM cell array 1006 that correspond to the coupling matrix to multiply by, the plurality of cells of the SRAM cell array 1006 may provide signals on the bit lines (BL and [symbol] ). In some examples, the signals on the bit lines (BL and [symbol] ) may have a voltage differential corresponding to elements in a solution vector.

Input nodes of the circuitry for noise addition 1008 may be coupled to the bit lines and may receive the signals having the voltage differential. The circuitry for noise addition 1008 may add noise on the signals. In some examples, the noise may be similar to Gaussian noise. In some examples, the noise may be generated by discrete uniform noise generation. The discrete uniform noise generation may have some advantages for faster design time and expected performance. In some examples, noise may be digitally generated as some random bits in the circuitry for noise addition 1008, and the random bits may be provided through a digital-to-analog converter in the circuitry for noise addition 1008, and noise may be an added current on the signal. In some examples, noise may be generated as discrete Gaussian noise. In some examples, the SRAM cell array 1006 may be modified to include the circuitry for noise addition 1008. Thus, the circuitry for linear operation 1004 and the circuitry for noise addition 1008 may be implemented as either an integrated circuit or separate circuits. The circuitry for noise addition 1008 may provide the signals with noise to the circuitry for nonlinear operation 1010.

A nonlinear operation on the signals with noise may be performed by the circuitry for nonlinear operation 1010. In some examples, the nonlinear operation on the signals may be performed utilizing a comparator circuit 1012 in the circuitry for nonlinear operation 1010. The comparator circuit 1012 may include one or more comparators to form at least a portion of the circuitry for nonlinear operation 1010. The comparator circuit 1012 may be used for the nonlinear operation. In some examples, the comparators in the comparator circuit 1012 may be synchronous based on a clock signal. In some examples, the comparators in the comparator circuit 1012 may be asynchronous. The comparator circuit 1012 may provide the benefit of simpler circuit implementation without sacrificing significant accuracy or speed in comparison to other nonlinearities such as sinusoids. In some examples, a number of comparators in the comparator circuit 1012 may scale linearly with a number of nodes in the optimization problem.

Output nodes of the circuitry for nonlinear operation 1010 and input nodes of the circuitry for linear operation 1004 by the word lines (WL and [symbol] ). As described above, the circuitry for linear operation 1004, the circuitry for noise addition 1008, and the circuitry for nonlinear operation 1010 may be arranged in a feedback loop. Thus, the output vector values of the circuitry for nonlinear operation 1010 may be provided as the input vector values of the circuitry for linear operation 1004. Alternatively or eventually, the output vector values may be provided as representative of a solution to the optimization problem.

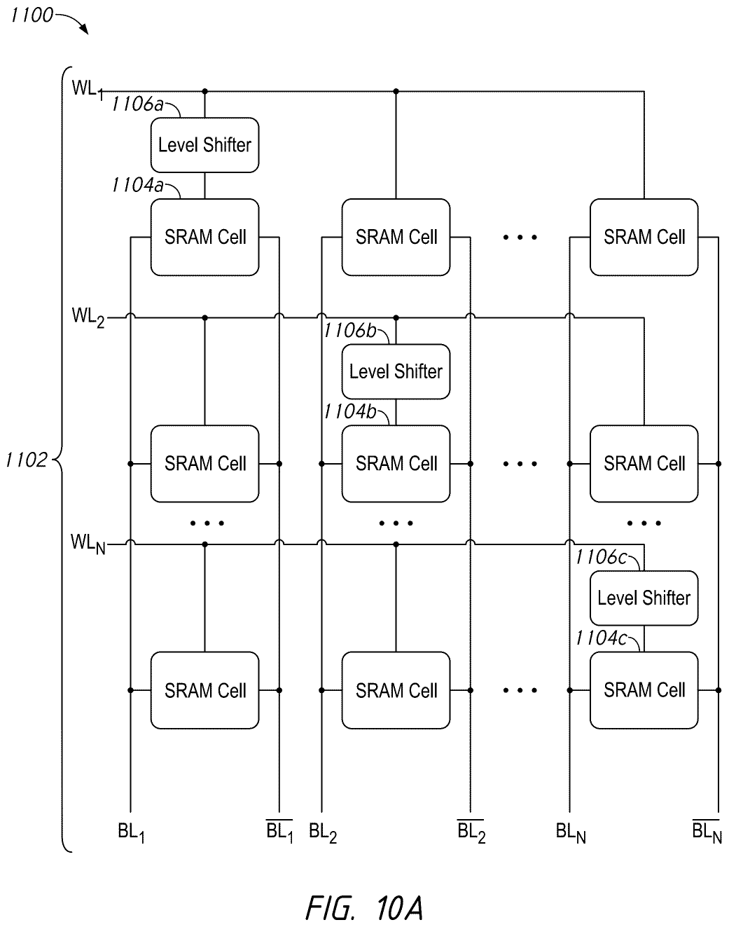

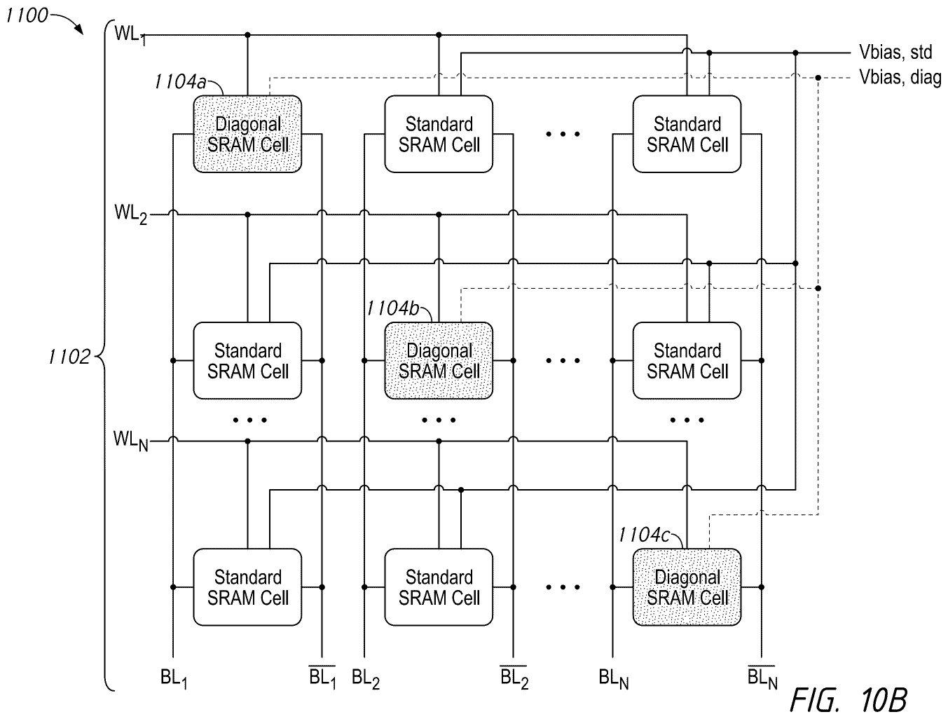

When the optimization problem is a MAXCUT problem, diagonal elements of the J matrix in the equation 702 is 0, because a MAXCUT problem has a “0” weight between a node and itself. Thus, using an identity matrix I, each input signal fb(x) of the circuitry for nonlinear operation 112 may also be represented by an equation 802, where the feedback offsets αx may be represented as feedback offsets αIx. FIGS. 10A and 10B are schematic illustrations of circuitry for linear operation 1100 including an SRAM cell array 1102 in accordance with examples described herein. In some examples, the loop parameters, such as the coupling strength β and the feedback strength α, may be implemented into the diagonal cells in the SRAM cell array 1102. In the examples of FIGS. 10A and 10B, the feedback strength (e.g., offset) α may be implemented as weights corresponding to value(s) of α with diagonal cells, including cells 1104a, 1104b, and 1104c of the SRAM cell array 1102, and the coupling strength β may be implemented as weights corresponding to the value of β with the other cells (e.g., nondiagonal cells) of the SRAM cell array 1102. In some examples, as shown in FIG. 10A the weights α with diagonal cells, including cells 1104a, 1104b, and 1104c of the SRAM cell array 1102, may be implemented as respective level shifters, including level shifters 1106a, 1106b, and 1106c, coupled between respective word lines WL₁, WL₂, WL_{N} and the diagonal cells including the cells 1104a, 1104b, and 1104c. The level shifters of FIG. 10A coupled to each diagonal cell may provide a bias voltage to shift a voltage of the respective word line, and thus may effectively change the weight of the respective cell in current contribution. In some examples, the coupling strength β may be also provided as bias voltage to each cell of non-diagonal cells. In some examples, as shown in FIG. 10B, the feedback strength α may be provided as a bias voltage Vbias, diag proportional to a to each cell of diagonal cells, including cells 1104a, 1104b, and 1104c of the SRAM cell array 1102, and the coupling strength β may be also provided as a bias voltage Vbias,std proportional to β to each cell of non-diagonal cells. Each weight of each cell may be provided to represent each cell's ability to provide a current and sizes of transistors in each cell. Applying the weights through shift registers in the SRAM cell array 1102 that performs matrix multiplication may not cause major modification to hardware, and such weights applications through the shift registers may reduce additional latency.

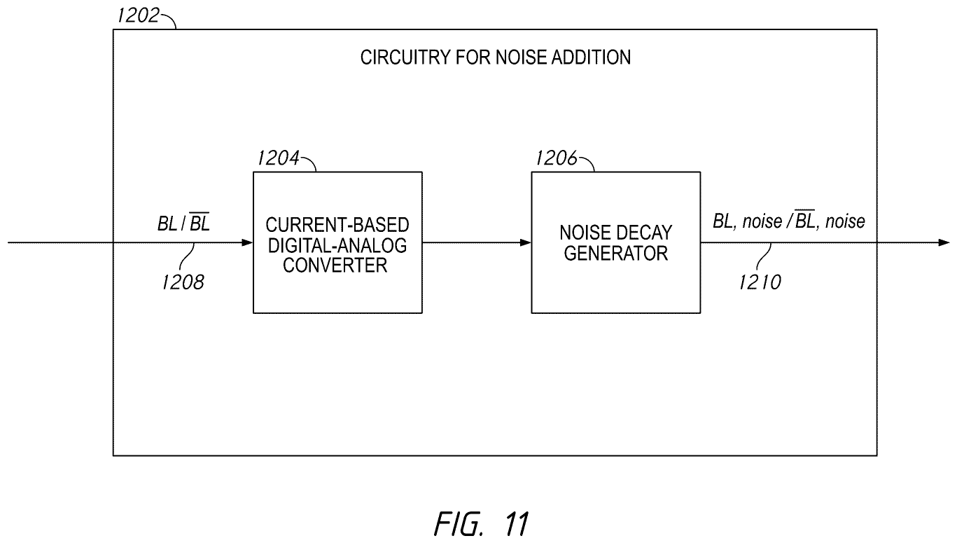

FIG. 11 is a schematic illustration of an example of circuitry for noise addition 1202 in accordance with examples described herein. The circuitry for noise addition 1202 may be a noise generator, including a current-based digital-to-analog converter (DAC) 1204 and a noise decay generator 1206. In some examples, the current-based DAC may be a current mirror circuit having multiple current mirror branches that are controlled by digital input signals to provide higher or lower current values proportional to the digital input signals. In some examples, the noise decay generator 1206 may be a resistive DAC. The circuitry for noise addition 1202 may provide a current noise profile that may be decaying and following a random uniform distribution across multiple possible values. The circuitry for noise addition 1202 may be fabricated in a same process as other circuitry (e.g., circuitry for linear operation, circuitry for nonlinear operation 1506, etc.).

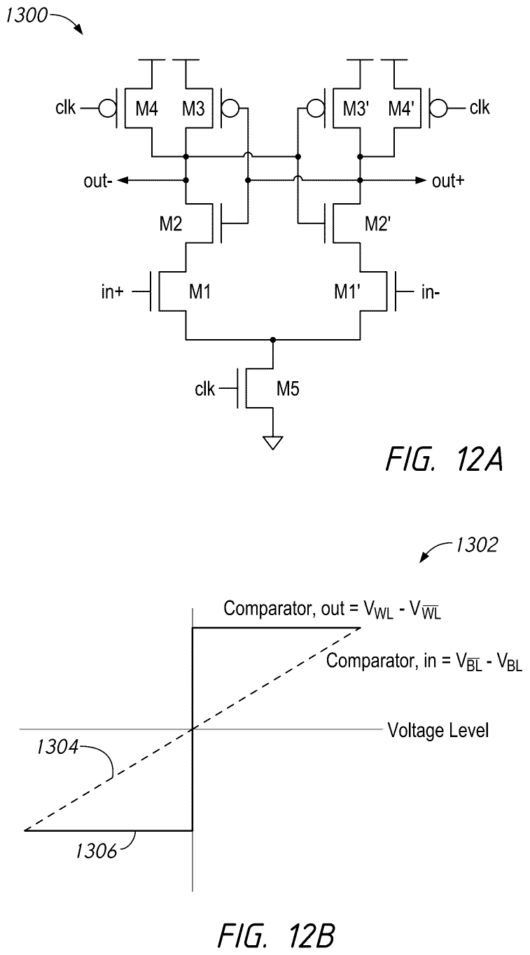

In some examples, circuitry for nonlinear operation may include a comparator circuit including differential comparators. FIG. 12A illustrates an example of a comparator 1300 in circuitry for nonlinear operation in accordance with examples described herein. The comparator 1300 may be a dynamic latched comparator using the Strong-Arm Latch topology. The comparator 1300 may be fabricated with a same semiconductor fabrication process or on a same semiconductor substrate, using a semiconductor fabrication technology, such as CMOS fabrication technology. Accordingly, the comparator 1300 may be fabricated in a same process as other circuitry in combinatorial optimization circuitry.

The comparator 1300 may receive an analog differential signal based on signals on lines (BL, noise, and B̅L̅, noise|) that is obtained from signals provided by circuitry for linear operation, such as an SRAM cell array, with added circuitry for noise addition, provided on input nodes in+ and in− of MI transistors in the comparator 1300. The comparator 1300 may detect relatively small voltage differences between voltages of the signals on the lines (BL, noise, and B̅L̅, noise|), as low as to a range of millivolt (mV). In the comparator 1300, the signal on the line (BL, noise) is a higher voltage than the voltage of the signal on the line (B̅L̅, noise|). An output differential voltage between output nodes out+ and out− may be represented as “−1”, where a signal on a word line [symbol] has a relatively high voltage and a signal on a word line WL has a relatively low voltage. Similarly, if the signal on the line (BL, noise) has a lower voltage than the voltage of the signal (B̅L̅, noise|), the output differential voltage between output nodes out+ and out− may be represented as is a “1”, where a signal on the word line WL has a relatively high voltage and a signal on the word line [symbol] has a relatively low voltage. The comparator 1300 may receive clock signals clk at transistors coupled to a power supply voltage line and/or a ground line. The comparator 1300 may synchronously digitize signals from memory cells of the SRAM array with added noise.

FIG. 12B illustrates a relationship 1302 between differential signals of the comparator 1300 in accordance with examples described herein. A transfer function of the comparator 1300 is shown in FIG. 12B, where a differential voltage of signals (BL, noise) and (B̅L̅, noise|) in a linear relationship represented in a line 1304 is transferred to a differential voltage between signals (WL and [symbol] ) in a discrete relationship represented in a curve 1306 that works as a nonlinearity.

The comparator 1300 is merely exemplary in nature, and the comparator 1300 may be implemented in various manners and not limited to the dynamic latched comparator using the Strong-Arm Latch topology. In some examples, comparators may be asynchronous. The comparators may provide the benefit of simpler circuit implementation without sacrificing significant accuracy or speed in comparison to other nonlinearities such as sinusoids.

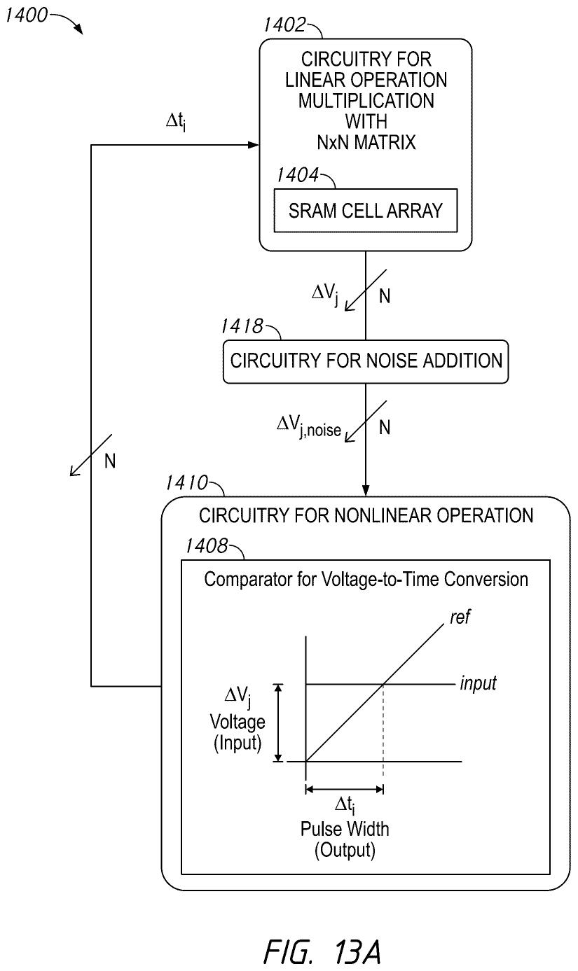

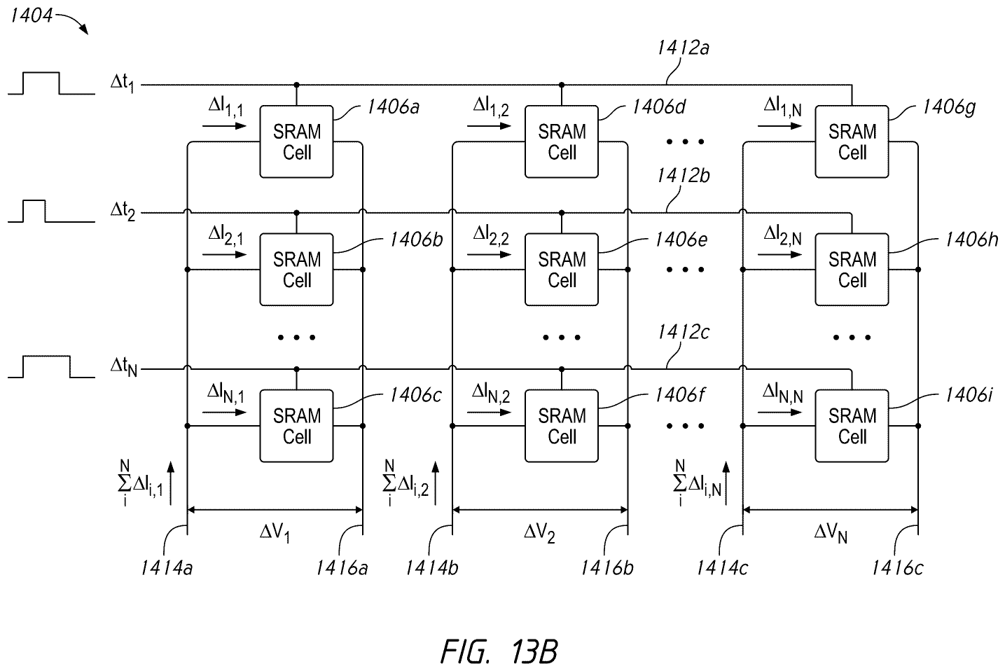

In some examples, signals with a differential voltage represented in an analog voltage level may be converted to signals with a corresponding pulse width of a digital signal. FIG. 13A is a schematic illustration of a device 1400 implementing an Ising machine including comparators 1410 for nonlinear operations in accordance with examples described herein. The device 1400 may include circuitry for linear operation 1402 and circuitry for nonlinear operation 1408. The device 1400 may further include circuitry for noise addition 1418 coupled to the SRAM cell array 1404 and the circuitry for nonlinear operation 1408; however, the description of the circuitry for noise addition is omitted for brevity.

The circuitry for linear operation 1402 may include an SRAM cell array 1404 that may include a plurality of cells. In some embodiments, the plurality of cells may be arranged in N columns and N rows where N is a natural number. The plurality of cells may be programmed to store corresponding element values of a matrix having N columns and N rows. The SRAM cell array 1404 may receive an input vector at N word lines. Each input signal of N word line is a pulse signal that takes between two voltage levels for a variable time period represented by a variable pulse width. The pulse widths of each word line may be proportional to a value of each element of the input vector. In SRAM-based computing, each cell may sink a certain amount of current, based on the input value at the word line and the stored value on each cell. Thus, matrix multiplication by multiplying the input vector by the stored N×N matrix may be performed in the SRAM cell array 1404.

FIG. 13B is a schematic illustration of an SRAM cell array 1404 in accordance with examples described herein. FIG. 13B illustrates shows how a time pulse can be “multiplied” with the stored values through current summation in the SRAM cell array 1404. A larger pulse width in an input signal corresponds to a larger current sink and a larger contribution to a voltage differential drop between a pair of bit lines as an output signal. In some examples, the effect of correspondence between the pulse width in a time domain and the voltage differential drop has been demonstrated with transistor-level simulations.

A current at each cell's output line (e.g., bit lines) is summed for a column of cells, resulting in a differential voltage between a pair of bit lines. In the example of FIG. 13B, a word line 1412a coupled to N cells, including cells 1406a, 1406d, and 1406g, provides an input signal with a pulse width Δt₁. The cells 1406a, 1406d, and 1406g may sink currents ΔI_{1,1}, ΔI_{1,2}, ΔI_{1,N} based on the input value at the word line that lasts for the pulse width Δt₁ and the stored matrix value on the cells 1406a, 1406d, and 1406g. A word line 1412b coupled to N cells, including cells 1406b, 1406e, and 1406h, provides an input signal with a pulse width Δt₂. The cells 1406b, 1406e, and 1406h may sink currents ΔI_{2,1}, ΔI_{2,2}, ΔI_{2,N} based on the input value (e.g., a logic level “1”) at the word line that lasts for the pulse width Δt₂ and the stored matrix value on the cells 1406b, 1406e, and 1406h. A word line 1412c coupled to N cells, including cells 1406c, 1406f, and 1406i, provides an input signal with a pulse width Δt_{N}. The cells 1406c, 1406f, and 1406i may sink currents ΔI_{N,1}, ΔI_{N,2}, ΔI_{N,N} based on the input value at the word line that lasts for the pulse width Δt_{N} and the stored matrix value on the cells 1406c, 1406f, and 1406i. A pair of bit lines 1414a and 1416a is coupled to N cells 1406a, 1406b, . . . 1406c. The amount of the current on the bit line 1414a at an output node may be computed as Σᵢ^{N}Δ_{i,1}. A pair of bit lines 1414b and 1416b is coupled to N cells 1406d, 1406e, . . . 1406f. The amount of the current on the bit line 1414b at an output node may be computed as Σᵢ^{N}Δ_{i,2}. A pair of bit lines 1414c and 1416c is coupled to N cells 1406g, 1406h, . . . 1406i. The amount of the current on the bit line 1414c at an output node may be computed as Σᵢ^{N}Δ_{i,N}. Based on the amount of the current, the differential voltages ΔV₁, ΔV₂, . . . ΔV_{N} may be computed. Thus, as a result of the matrix multiplication, the SRAM cell array 1404 may provide N differential voltages ΔVj (1≤j≤N).

Accordingly, input vector values applied to combinatorial optimization circuitry described herein may be applied by applying respective pulse widths at each input line of an array of SRAM cells. The pulse width provided at each line may be proportional to the corresponding intended input vector value. To implement this type of computing in example Ising machine devices, some conversion between the multiplication's output voltage and input pulse may be performed. In some examples, the circuitry for nonlinear operation 1408 may include comparators 1410 that may provide different results with respect to a reference voltage. As shown in FIG. 13A, each of N differential voltages ΔVj (1≤j≤N) from the SRAM cell array 1404 may be received at the corresponding comparator 1410. The corresponding comparator 1410 may compare the differential voltage ΔVj with the reference voltage. The corresponding comparator 1410 keeps providing an output signal at a high level while the differential voltage ΔVj exceeds the reference voltage, whereas the corresponding comparator 1410 starts providing the output signal at a low level once the reference voltage exceeds the differential voltage ΔVj. Thus the output signals may have pulse widths Δtᵢ (1≤i≤N) that are proportional to the differential voltages ΔVj (1≤j≤N). The N word lines may transmit digital signals with pulse width Δtᵢ (1≤i≤N) to the circuitry for linear operation 1402 as feedback signals, and the device 1400 may continue the optimization process. In this manner, time-based analog computing may be implemented in part by mapping output differentials from the SRAM cells to variable pulse widths using a reference voltage.

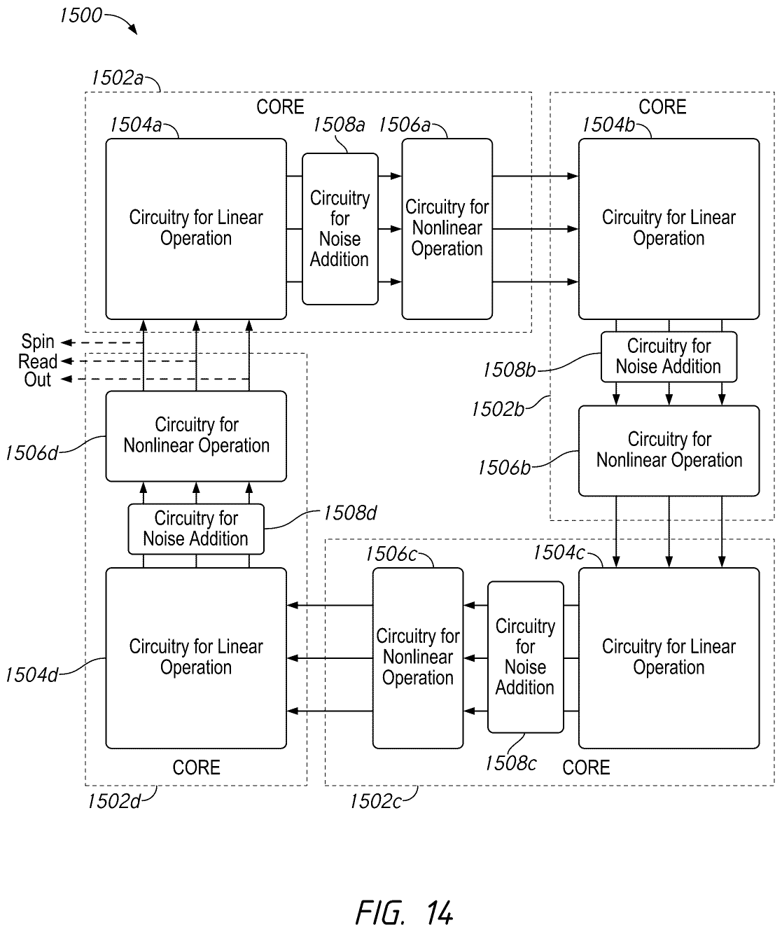

An advantage of vector-based operations is that the architecture is fully parallel when multi-core architecture linear-nonlinear operations are implemented. FIG. 14 is a schematic illustration of a device 1500 implementing an Ising machine including a multi-core architecture in accordance with examples described herein. The implementation in FIG. 14 utilizes a quad core architecture; however, any number of cores that is equal to or greater than two may be utilized to perform the feedback loop of linear-nonlinear operations for optimization problems. This allows the device operations to be fully parallel, eliminating or reducing multiplexing latency.

Accordingly, FIG. 14 illustrates multiple instances of linear operation and nonlinear operation circuitry pairs. There are four instances (e.g., quad cores 1502a-1502d) in the example of FIG. 14, but other numbers of instances may be used in other examples. Each pair of the core (e.g., circuitry for linear operation 1504a and circuitry for nonlinear operation 1506a, circuitry for linear operation 1504b and circuitry for nonlinear operation 1506b, circuitry for linear operation 1504c and circuitry for nonlinear operation 1506c, circuitry for linear operation 1504d and circuitry for nonlinear operation 1506d), coupled in series, with intervention of circuitry for noise addition (e.g., circuitry for noise addition 1508a, 1508b, 1508c, 1508d) between circuitry for linear operation and circuitry for nonlinear operation of each core, with the feedback from the last pair in series to the first pair. In some examples, the circuitry for linear operation 1504a may be followed by the circuitry for noise addition 1508a, then the circuitry for nonlinear operation 1506a, followed by the circuitry for linear operation 1504b, then the circuitry for noise addition 1508b, then the circuitry for nonlinear operation 1506b, then the circuitry for linear operation 1504c, then the circuitry for noise addition 1508c, then the circuitry for nonlinear operation 1506c, then the circuitry for linear operation 1504d, then the circuitry for noise addition 1508d, then the circuitry for nonlinear operation 1506d, and an output of the circuitry for nonlinear operation 1506d may be coupled to the circuitry for linear operation 1504a. Thus, multiple iterations of calculations may be performed through a chain of multiple instances.

Accordingly, combinatorial optimization circuitry (e.g., an Ising machine) including circuitry for linear operation, circuitry for noise addition, and circuitry for nonlinear operation may be provided in accordance with examples described herein that may be implemented by a same semiconductor fabrication process or on a same semiconductor substrate, using a semiconductor fabrication technology, such as CMOS fabrication technology. Accordingly, the combinatorial optimization circuitry may be fabricated in a same process as other circuitry (e.g., one or more CPUs, GPUs, and/or other circuitry). For example, the combinatorial optimization circuitry disclosed throughout the FIGS. 1-14 may be formed in a semiconductor substrate. That same semiconductor substrate may also be used to form other circuitry-a CPU, GPU, post-processing circuitry, etc. Conductive traces may be provided on the semiconductor substrate that may couple the combinatorial optimization circuitry to the other circuitry (e.g., to the CPU and/or GPU). In this manner, tight integration of combinatorial optimization circuitry and other circuitry may be achieved.

From the foregoing it will be appreciated that, although specific embodiments of the disclosure have been described herein for purposes of illustration, various modifications may be made without deviating from the spirit and scope of the disclosure.

The particulars shown herein are by way of example and for purposes of illustrative discussion of the preferred embodiments of the present disclosure.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments, or processes described herein may be combined with one or more other examples, embodiments, and/or processes or be separated and/or performed among separate devices or device portions in accordance with the present systems, devices, and methods.

Finally, the above discussion is intended to be merely illustrative of the present method, device, and system and should not be construed as limiting the appended claims to any particular embodiment or group of embodiments. Thus, while the present method, device, and system have been described in particular detail with reference to exemplary embodiments, it should also be appreciated that numerous modifications and alternative embodiments may be devised by those having ordinary skill in the art without departing from the broader and intended spirit and scope of the present method, device, and system as set forth in the claims that follow. Accordingly, the specification and drawings are to be regarded in an illustrative manner and are not intended to limit the scope of the appended claims.

What is claimed is:

1. A method comprising:
applying one or more input vector values to combinatorial optimization circuitry;
performing multiple iterations of calculations using the combinatorial optimization circuitry, each iteration of the multiple iterations comprising:
performing a linear operation on the one or more input vector values utilizing static random memory (SRAM) cells, the SRAM cells programmed to store values of a coupling matrix representative of an optimization problem;
providing first signals from the SRAM cells;
adding noise on the first signals and providing second signals; and
performing a nonlinear operation on the second signals; and
providing one or more output vector values from the multiple iterations of calculations, the output vector values representative of a solution to the optimization problem.

2. The method of claim 1, wherein the noise comprises Gaussian noise.

3. The method of claim 1, wherein the noise comprises discrete uniform noise.

4. The method of claim 1, wherein the linear operation comprises matrix multiplication between the one or more input vector values and the coupling matrix.

5. The method of claim 1, wherein each iteration comprises multiple linear operations followed by nonlinear operations in a feedback configuration.

6. The method of claim 1, further comprising mapping differential voltages from the SRAM cells to variable pulse widths using a reference voltage, wherein the differential voltages are based on the first signals.

7. The method of claim 1, further comprising programming the SRAM cells to store the values of the coupling matrix representative of the optimization problem, comprising providing bias voltages to at least a portion of cells in the SRAM cells.

8. The method of claim 7, wherein the bias voltages are provided to every cell of the SRAM cells.

9. The method of claim 7, wherein the bias voltages provided to diagonal cells and nondiagonal cells of an SRAM cell array comprising the SRAM cells are different.

10. The method of claim 9, wherein the optimization problem is a MAXCUT problem.

11. A device comprising:
a processor formed in a semiconductor substrate; and
combinatorial optimization circuitry formed in the semiconductor substrate, the combinatorial optimization circuitry comprising:
a plurality of SRAM cells;
noise generation circuitry coupled to the plurality of SRAM cells; and
circuitry configured to perform a nonlinear operation the circuitry coupled to the noise generation circuitry.

12. The device of claim 11, further comprising conductive traces on the semiconductor substrate, the conductive traces coupling the processor to the combinatorial optimization circuitry.

13. The device of claim 11, further comprising multiple instances of:
the plurality of SRAM cells;
the noise generation circuitry; and
the circuitry configured to perform the nonlinear operation,
arranged in a feedback configuration.

14. The device of claim 11, wherein the processor is configured to provide one or more input vector values to the combinatorial optimization circuitry, to receive one or more output vector values from the combinatorial optimization circuitry, and further configured to solve an optimization problem using the one or more output vector values.

15. The device of claim 14, wherein the plurality of SRAM cells comprise diagonal cells coupled to respective shift registers, and
wherein the optimization problem is a MAXCUT problem.

16. A device comprising:
combinatorial optimization circuitry configured to perform iterations of calculations and to provide an output from the iterations of calculations, the output representative of a solution to an optimization problem, the combinatorial optimization circuitry comprising:
first circuitry configured to receive input vector values, to perform a linear operation on the input vector values to provide first signals, the first circuitry comprising a plurality of SRAM cells configured to store values of a coupling matrix representative of the optimization problem;
noise generation circuitry configured to add noise on the first signal and to provide second signals; and
second circuitry configured to perform a nonlinear operation on the second signals and further configured to provide output vector values to the first circuitry.

17. The device of claim 16, further comprising an SRAM programmer configured to program the plurality of SRAM cells to store the values of the coupling matrix representative of the optimization problem.

18. The device of claim 16, wherein the first circuitry comprises shift registers coupled to respective diagonal cells of an SRAM cell array comprising the SRAM cells, wherein the shift registers are configured to provide respective bias voltages to the diagonal cells of the SRAM cell array.

19. The device of claim 16, wherein the noise generation circuitry comprises:
a current-based digital converter configured to generate random digital signals as noise signal; and
a resistive digital-to-analog converter configured to provide decay of the noise signal.

20. The device of claim 16, wherein the second circuitry comprises one or more biasing transistors configured to perform the nonlinear operation.

21. The device of claim 16, wherein the first circuitry is configured to multiply the input vector values by the values of the coupling matrix to provide products, and to sum the products.

22. The device of claim 21, wherein each SRAM cell of the plurality of SRAM cells is configured to receive a corresponding input vector value on a word line coupled to each SRAM cell, and configured to provide currents on a pair of bit lines to provide a differential voltage.

23. The device of claim 22, wherein the second circuitry is coupled to a plurality of word lines including the word line configured to provide a corresponding output vector value of the output vector values based on the nonlinear operation on the differential voltage.

24. The device of claim 23, wherein the second circuitry comprises a comparator circuit configured to compare the differential voltage from the SRAM cells with a reference voltage and further configured to provide a variable pulse width based on the comparison.
